(19) United States
(12) Patent Application Publication
(10) Pub. No.: US 2009/0003943 A1
(43) Pub. Date: Jan. 1, 2009

(54) COATED CEMENTED CARBIDE CUTTING TOOL INSERT

(75) Inventors: Marie PETTERSSON, Alvsjo (SE); Anders LUNDQVIST, Vendelso (SE); Susanne NORGREN, Huddinge (SE); Toril MYRTVEIT, Kungsangen (SE); Rickard SUNDSTROM, Alta (SE)

Correspondence Address: DRINKER BIDDLE & REATH (DC), 1500 K STREET, N.W., SUITE 1100, WASHINGTON, DC, 20005-1209, US

(73) Assignee: SANDVIK INTELLECTUAL PROPERTY AB, Sandviken (SE)

(21) Appl. No.: 12/130,076

(22) Filed: May 30, 2008

(30) Foreign Application Priority Data
Jun. 1, 2007 (SE) 0701320-4

(51) Int. Cl. B23C 5/20; B32B 5/00; B22F 7/04

(52) U.S. Cl. 407/33; 428/336; 419/8; 409/64; 408/144

(57) ABSTRACT

The present invention relates to PVD coated cemented carbide cutting tool inserts roughing to finishing milling operations. The cemented carbide cutting tool insert comprises a substrate and a wear resistant coating. The substrate comprises in addition to WC, from about 5.5 to about 8.5 wt-% Co and Cr such that the Cr/Co weight ratio is from about 0.08 to about 0.12 and also small amounts of Ti and Ta. The wear resistant coating is a homogeneous AlₓTi₁₋ₓN-layer with x equals from about 0.6 to about 0.67. The thickness of this layer is from about 1.2 to about 3.6 μm.

### CROSS-REFERENCE TO PRIOR APPLICATION

This application claims priority to Swedish Patent Application No. 0701320-4 filed Jun. 1, 2007, which is incorporated by reference herein.

### BACKGROUND OF THE INVENTION

The present invention relates to a coated cemented carbide cutting tool insert. More specifically, the invention relates to PVD coated cemented carbide cutting tool inserts useful from roughing to finishing in metal cutting operations.

High performance cutting tools must possess high wear resistance, high toughness properties and good resistance to plastic deformation. This is particularly valid when the cutting operation is carried out at high cutting speeds and/or at high feed rates when large amount of heat is generated.

Cemented carbide grades for metal machining applications generally contain WC, γ-phase, which is a solid solution of generally TiC, NbC, TaC and WC, and a binder phase, generally Co and/or Ni. WC-Co cemented carbides having a fine grain size less than about 1 μm are produced through the incorporation of grain growth inhibitors such as V, Cr, Ti, Ta and combinations thereof in the initial powder blend. Typical inhibitor additions are from about 0.5 to about 5 wt-% of the binder phase.

### OBJECTS AND SUMMARY OF THE INVENTION

It is an object of the present invention to provide inserts with a coated cemented carbide with improved wear resistance without sacrificing toughness and edge security, particularly useful for roughing to finishing operations of metal materials.

This object is solved by providing a cemented carbide insert consisting of a WC+Co-substrate with fine grain size provided with a PVD coating.

In one aspect of the invention, there is provided a cemented carbide cutting tool insert comprising a substrate and a wear resistant coating, wherein the substrate comprises WC, from about 5.5 to about 8.5 wt-% Co and Cr such that the Cr/Co weight ratio is from about 0.08 to about 0.12, and also Ti and Ta in such amounts that the ratio of Me/Co=(at % Ti+at % Ta)/at % Co is less than or equal to about 0.014−(CW-Cr)*0.008 and higher than about 0.0005 and CW-Cr is from about 0.75 to about 0.93 where CW-Cr is defined as CW-Cr=(magnetic-% Co+1.13*wt-% Cr)/wt-% Co where magnetic-% Co is the weight percentage of magnetic Co and wt-% Co is the weight percentage of Co in the cemented carbide, the coercivity is more than about 20 kA/m, and the wear resistant coating is a homogeneous AlₓTi₁₋ₓN-layer with x equals from about 0.6 to about 0.67 as measured by EDS on the flank side about 0.2 mm below the cutting edge and about 1 mm from the nose, with a thickness of more than about 1.2 μm, but less than about 3.6 μm, the coating thickness being measured on the flank face about 1 mm from the nose and about 0.2 mm below the nose radius.

In another aspect of the invention, there is provided a method of making a cemented carbide cutting tool insert comprising a substrate, a wear resistant coating comprising the following steps: providing a substrate comprising WC, from about 5.5 to about 8.5 wt-% Co and Cr such that the Cr/Co weight ratio is from about 0.08 to about 0.12 and also Ti and Ta in such amounts that the ratio of Me/Co=(at % Ti+at % Ta)/at % Co is less than or equal to about 0.014−(CW-Cr)*0.008 and higher than about 0.0005 and CW-Cr is from about 0.75 to about 0.93, where CW-Cr is defined as CW-Cr=(magnetic-% Co+1.13*wt-% Cr)/wt-% Co where magnetic-% Co is the weight percentage of magnetic Co and wt-% Co is the weight percentage of Co in the cemented carbide and the coercivity is more than about 20 kA/m, wet milling submicron powders of tungsten carbide, cobalt, Ti and Ta added as TiC, TaC, (Ti,W)C, (Ta,W)C or (Ti,Ta,W)C and at least one of Cr₃C₂, Cr₂₃C₆ and Cr₇C₃ to obtain a slurry, drying the slurry to obtain a powder, pressing the powder to inserts, sintering the inserts in vacuum, possibly performing an isostatic gas pressure step during sintering temperature or at the final stage of sintering, possibly grinding the inserts to requested shapes, depositing by arc evaporation technique whilst maintaining a partial pressure of nitrogen in the recipient, and using the appropriate selection of active evaporation sources and rates a wear resistant coating comprising a homogeneous AlₓTi₁₋ₓN-layer with x equals about from about 0.6 to about 0.67 as measured by EDS on the flank side about 0.2 mm below the cutting edge and about 1 mm from the nose, with a thickness of more than about 1.2 μm but less than about 3.6 μm, thickness being measured on the flank face about 0.2 mm below the nose radius and about 1 mm from the nose.

In still a further aspect of the invention, there is provided the use of an insert as described above for roughing to finishing operations in milling applications of work pieces with a hardness of from about 30 to about 65 HRC.

In yet still another aspect of the invention, there is provided the use of an insert as described above for machining in cast iron application in finishing operations at cutting speeds of from about 250 to about 1200 m/min, tooth feed of from about 0.05 to about 0.2 mm/tooth and axial depth of cut of from about 0.15 to about 1 mm in milling application.

### DETAILED DESCRIPTION OF THE PREFERRED EMBODIMENTS

According to the present invention, there is provided coated cemented carbide shaped inserts for roughing to finishing machining of metals, comprising a cemented carbide substrate, a wear resistant coating, and different insert geometries. The substrate comprises in addition to WC from about 5.5 to about 8.5, preferably from about 6 to about 8, wt-% Co and Cr such that the Cr/Co weight ratio is from about 0.08 to about 0.12, preferably from about 0.09 to about 0.11. The substrate also contains Ti and Ta in such amounts that the ratio

Me/Co=(at % Ti+at % Ta)/at % Co

is less than or equal to about 0.014−(CW-Cr)*0.008 and higher than 0.0005, preferably higher than about 0.0007 and CW-Cr is from about 0.75 to about 0.95, preferably from about 0.78 to about 0.93, where

CW-Cr=(magnetic-% Co+1.13*wt-% Cr)/wt-% Co

where magnetic-% Co is the weight percentage of magnetic Co and wt-% Co is the weight percentage of Co in the cemented carbide. CW-Cr ratio is a function of the W content in the Co binder phase. A CW-Cr of about 1 corresponds to a low W-content in the binder phase and a CW-Cr of from about 0.75 to about 0.93, preferably from about 0.8. to about 0.88, corresponds to a high W-content in the binder phase.

The coercivity is more than about 20 kA/m, preferably from about 23 to about 31 kA/m, most preferably from about 26 to about 29 kA/m. The sintered body may also contain small amounts of precipitations of additional phase or phases such as eta-phase, MX or M₇X₃, M₃X₂ where M=(Ti+Ta+Co+Cr+W) and X=C or N may be allowed to a maximum of about 5.0 vol % without detrimental effects.

The wear resistant coating comprises a homogeneous AlₓTi₁₋ₓN-layer with x equals from about 0.6 to about 0.67, preferably x equals from about 0.63 to about 0.64 as measured by EDS on the flank side about 0.2 mm below the cutting edge and about 1 mm from the nose. The thickness of the layer is more than about 1.2 μm, preferably more than about 1.5 μm but less than about 3.6 μm, preferably less than about 3.3 μm. The coating thickness is measured on a polished cross section performed on the flank side of the insert about 0.2 mm below the nose radius, about 1 mm from the nose.

The present invention also relates to a method of making cemented carbide cutting tool inserts for roughing to finishing operations in milling applications, comprising the following steps:

providing a cemented carbide substrate with a composition according to above by:
wet milling submicron powders of tungsten carbide, cobalt, Ti and Ta added as TiC, TaC, (Ti,W)C, (Ta,W)C or (Ti,Ta,W)C and at least one of Cr₃C₂, Cr₂₃C₆ and Cr₇C₃ to obtain a slurry,
drying the slurry to obtain a powder,
pressing the powder to inserts,
sintering the inserts in vacuum,
possibly performing an isostatic gas pressure step during sintering temperature or at the final stage of sintering,
possibly grinding the inserts to desired shapes,
depositing by arc evaporation technique whilst maintaining a partial pressure of nitrogen in the recipient, and using the appropriate selection of active evaporation sources and rates,
a wear resistant coating comprising a homogeneous AlₓTi₁₋ₓN-layer with x equals from about 0.6 to about 0.67, preferably x equals from about 0.63 to about 0.64.

The thickness of the layer is more than about 1.2 μm, preferably more than about 1.5 μm but less than about 3.6 μm, preferably less than about 3.3 μm, the composition and the thickness being measured on the flank face about 0.2 mm below the nose radius and about 1 mm from the nose.

A first embodiment of the present invention relates to the use of inserts according to above for milling applications in harder steels and hardened steels in roughing to finishing operations in work pieces with a hardness of from about 36 to about 65 HRC, for such as die and mold:
at cutting speeds of from about 40 to about 200 m/min, feed rates of from about 0.05 to about 0.3 mm/rev and depth of cut of from about 0.02 to about 3 mm in milling applications.

A second embodiment the present invention relates to the use of inserts according to above for machining in cast iron application in finishing operations:
at cutting speeds of 250-1200 m/min, tooth feed of 0.05-0.2 mm/tooth and axial depth of cut of 0.15-1 mm in milling applications.

The invention is additionally illustrated in connection with the following examples, which are to be considered as illustrative of the present invention. It should be understood, however, that the invention is not limited to the specific details of the examples.

### EXAMPLE 1

Tungsten carbide powder, 7 wt % very fine grained cobalt powder and 0.7 wt-% Cr added as H.C. Starck fine grained Cr₃C₂-powder, 0.014 wt-% Ti and 0.010 wt-% Ta, added as TiC and TaC, were wet milled together with conventional pressing agents. After milling and spray drying the powder was pressed to shape blanks for inserts and sintered at 1410° C. The sintered material had a coercivity of 27 kA/m corresponding to a WC grain size of about 0.8-0.9 μm. Substrate data are summarized in the table below.

| | | | | | | | | 0.014- |
|---|---|---|---|---|---|---|---|---|
| | | | | | | | CW- | (CW- |
| | W % Ti | W % Ta | Me/Co | W % Co | W % Cr | W % Cr/w % Co | Cr | Cr) * 0.008 |
| Substrate | 0.014 | 0.010 | 0.0029 | 7.00 | 0.70 | 0.10 | 0.85 | 0.0062 |
| data | | | | | | | | |

The inserts were wet cleaned. A homogeneous (Ti,Al)N layer was deposited by cathodic arc evaporation using a target material consisting of a Ti_{0.33}Al_{0.67} alloy in an N₂ gas atmosphere. The thickness of the layer was 2.5 μm and was a homogeneous layer with the composition Al_{0.63}Ti_{0.37}N as determined by EDS-analysis, using a SEM Hitachi S-4300, Oxford Instrument Link INCA.

### EXAMPLE 2

Inserts from Example 1 were tested and compared with inserts of a commercially available market reference (grade, coating, shape) for the intended application area. The test represents the upper range in terms of work piece hardness

| | |
|---|---|
| Operation: | Profiling, Coromill 216 |
| Work-piece: | mold |
| Material: | Cold work steel, 62 HRc |
| Cutting speed: | 72 m/min |
| Feed rate/tooth: | 0.235 mm/tooth |
| Axial depth of cut: | 3.0 mm |
| Radial depth of cut: | 1.5 mm |
| Insert-style: | R216-3006M-M |
| Cutter diameter: | 30 mm |

Note:
two insert in the cutter, dry machining.

Tool-life criterion edgeline toughness and chipping.

A combination of better edge line security and better wear resistance gave a considerable increase in tool life.

| Results: | Tool-life, minutes in cut |
|---|---|
| Prior art B: | 25 |
| Invention A: | 45 |

### EXAMPLE 3

Inserts from Example 1 were tested and compared with inserts of a commercially available market reference (grade, coating, shape) for the intended application area. The test represents the upper range in terms of work piece hardness

| | |
|---|---|
| Operation: | Face milling, Coromill 245 |
| Work-piece: | cylinder |
| Material: | High alloyed steel, 16MnCrS5, 62 HRc |
| Cutting speed: | 40 m/min |
| Feed rate/tooth: | 0.10 mm/tooth |
| Axial depth of cut: | 2.0 mm |
| Radial depth of cut: | 50 mm |
| Insert-style: | R245-12T3E-PL |
| Cutter diameter: | 63 mm |

Note:
5 insert in the cutter, dry machining.

Tool-life criterion was flank wear and edgeline toughness

A combination of better comb crack resistance leading to good edge line security and gave a considerable increase in tool life.

| | |
|---|---|
| Results: | Tool-life, minutes in cut |
| Prior art B: | 50 min |
| Invention A: | 120 min |

### EXAMPLE 4

Inserts from Example 1 were tested and compared with inserts of a commercially available market reference for the intended application area. The test represents finishing in ISO-K area

| | |
|---|---|
| Operation: | Face milling, Coromill 390 |
| Work-piece: | cylinder |
| Material: | SS0125, Grey cast iron |
| Cutting speed: | 1093 m/min |
| Feed rate/tooth: | 0.07 mm/tooth |
| Axial depth of cut: | 0.2 mm |
| Radial depth of cut: | 30 mm |
| Insert-style: | R390-11T308M-PL |
| Cutter diameter: | 40 mm |

Note:
6 insert in the cutter, dry machining.

Tool-life criterion was flank wear leading to bad surface finish.

A better wear resistance gave a considerable increase in tool life.

| | |
|---|---|
| Results: | Tool-life, minutes in cut |
| Prior art B: | 165 min |
| Invention A: | 500 min |

### EXAMPLE 5

Inserts from Example 1 were tested and compared with GC1030 reference. The test represents the middle area of hardness.

| | |
|---|---|
| Operation: | Face milling, Coromill 300 |
| Work-piece: | Forging die |
| Material: | W. nr: 1.2343, 53 Hrc |
| Cutting speed: | 90 m/min |
| Feed rate/tooth: | 0.40 mm/tooth |
| Axial depth of cut: | 0.40 mm |
| Radial depth of cut: | 25 mm |
| Insert-style: | R300-1240M-PH |
| Cutter diameter: | 40 mm |

Note:
4 insert in the cutter, dry machining.

Tool-life criterion was resistance to plastic deformation and flank wear.

A better resistance to plastic deformation and better wear resistance gave a considerable increase in tool life. The application area is not for the intended Reference B.

| | |
|---|---|
| Results: | Tool-life, minutes in cut |
| Reference B: | 4 min |
| Invention A: | 42 min |

### EXAMPLE 6

Inserts from Example 1 were tested and compared with inserts of a commercially available market reference (grade, coating, shape) for the intended application area. The test represents the upper range in terms of work piece hardness.

| | |
|---|---|
| Operation: | High finishing profiling, Coromill 216F |
| Work-piece: | Test work piece |
| Material: | W.nr: 1.2379, 63 HRc |
| Cutting speed: | 110 m/min |
| Feed rate/tooth: | 0.235 mm/tooth |
| Axial depth of cut: | 0.20 mm |
| Radial depth of cut: | 0.20 mm |
| Insert-style: | R216F-1640E-L |
| Cutter diameter: | 16 mm |

Note:
1 insert in the cutter, dry machining.

Tool-life criterion was flank wear

A better wear resistance gave a considerable increase in tool life.

| | |
|---|---|
| Results: | Tool-life, minutes in cut |
| Prior art B: | 675 min |
| Invention A: | 840 min |

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. Cemented carbide cutting tool insert comprising a substrate and a wear resistant coating, wherein:
the substrate comprises WC, from about 5.5 to about 8.5 wt-% Co and Cr such that the Cr/Co weight ratio is from about 0.08 to about 0.12, and also Ti and Ta in such amounts that the ratio of Me/Co=(at % Ti+at % Ta)/at % Co is less than or equal to about 0.014−(CW-Cr)*0.008 and higher than about 0.0005 and CW-Cr is from about 0.75 to about 0.93 where CW-Cr is defined as
CW-Cr=(magnetic-% Co+1.13*wt-% Cr)/wt-% Co
where magnetic-% Co is the weight percentage of magnetic Co and wt-% Co is the weight percentage of Co in the cemented carbide, the coercivity is more than about 20 kA/m, and the wear resistant coating is a homogeneous AlₓTi₁₋ₓN-layer with x equals from about 0.6 to about 0.67 as measured by EDS on the flank side about 0.2 mm below the cutting edge and about 1 mm from the nose, with thickness of more than about 1.2 μm, but less than about 3.6 μm, the coating thickness being measured on the flank face about 1 mm from the nose and about 0.2 mm below the nose radius.

2. The cemented carbide cutting tool insert of claim 1 wherein the substrate comprises from about 6 to about 8 wt-% Co, the Cr/Co-weight ratio is from about 0.09 to about 0.11, the ratio of Me/Co is higher than about 0.0007, the CW-Cr is from about 0.8 to about 0.88 and the coercivity is from about 23 to about 31 kA/m.

3. The cemented carbide cutting tool insert of claim 2 wherein the coercivity is from about 26 to about 29 kA/m.

4. The cemented carbide cutting tool insert of claim 1 wherein in the said wear resistant coating, x is from about 0.63 to about 0.64 and the thickness of said coating is greater than about 1.5 μm but less than about 3.3 μm.

5. Method of making a cemented carbide cutting tool insert comprising a substrate, a wear resistant coating comprising the following steps:
providing a substrate comprising WC, from about 5.5 to about 8.5 wt-% Co and Cr such that the Cr/Co weight ratio is from about 0.08 to about 0.12 and also Ti and Ta in such amounts that the ratio of Me/Co=(at % Ti+at % Ta)/at % Co is less than or equal to about 0.014−(CW-Cr)*0.008 and higher than about 0.0005 and CW-Cr is from about 0.75 to about 0.93, where CW-Cr is defined as:
CW-Cr=(magnetic-% Co+1.13*wt-% Cr)/wt-% Co
where magnetic-% Co is the weight percentage of magnetic Co and wt-% Co is the weight percentage of Co in the cemented carbide and the coercivity is more than about 20 kA/m,
wet milling submicron powders of tungsten carbide, cobalt, Ti and Ta added as TiC, TaC, (Ti,W)C, (Ta,W)C or (Ti,Ta,W)C and at least one of Cr₃C₂, Cr₂₃C₆ and Cr₇C₃ to obtain a slurry,
drying the slurry to obtain a powder,
pressing the powder to inserts,
sintering the inserts in vacuum, and
possibly performing an isostatic gas pressure step during sintering temperature or at the final stage of sintering
possibly grinding the inserts to requested shapes
depositing by arc evaporation technique whilst maintaining a partial pressure of nitrogen in the recipient, and using the appropriate selection of active evaporation sources and—rates a wear resistant coating comprising a homogeneous AlₓTi₁₋ₓN-layer with x equals about from about 0.6 to about 0.67 as measured by EDS on the flank side about 0.2 mm below the cutting edge and about 1 mm from the nose, with thickness of more than about 1.2 μm but less than about 3.6 μm, thickness being measured on the flank face about 0.2 mm below the nose radius about 1 mm from the nose.

6. The method of claim 5 wherein the substrate comprises from about 6 to about 8 wt-% Co, the Cr/Co-weight ratio is from about 0.09 to about 0.11, the ratio of Me/Co is higher than about 0.0007, the CW-Cr is from about 0.8 to about 0.88 and the coercivity is from about 23 to about 31 kA/m.

7. The method of claim 5 wherein the coercivity is from about 26 to about 29 kA/m.

8. The method of claim 5 wherein in the said wear resistant coating, x is from about 0.63 to about 0.64 and the thickness of said coating is greater than about 1.5 μm but less than about 3.3 μm.

9. Use of an insert of claim 1 for roughing to finishing operations in milling applications of work pieces with a hardness of from about 30 to about 65 HRC.

10. Use of an insert according to claim 1 for machining in cast iron application in finishing operations at cutting speeds of from about 250 to about 1200 m/min, tooth feed of from about 0.05 to about 0.2 mm/tooth and axial depth of cut of from about 0.15 to about 1 mm in milling applications.
